(19) United States
(12) Patent Application Publication
(10) Pub. No.: US 2002/0108488 A1
(43) Pub. Date: Aug. 15, 2002

(54) Piston support

(76) Inventors: Stefan Bonig, Wasserburg (DE); Franz Buchel, Ruggell (LI); Markus Frommelt, Schaan (LI); Thomas Sperrfechter, Zizers GR (CH)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 10/071,692

(22) Filed: Feb. 8, 2002

(30) Foreign Application Priority Data
Feb. 9, 2001 (DE) 101 05 883.7

(51) Int. Cl. F15B 15/26

(52) U.S. Cl. 92/15

(57) ABSTRACT

A piston support, in particular for a driving piston (8) of a setting tool, has a cylindrical section (10a) followed by a wedge-shaped section (10) extending toward the trailing end of the driving piston (8) and with a wedge-shaped surface (18) inclined inwardly towards the piston central axis (16). At least one braking element (23), presses against the cylindrical section (10a) in the ready-to-fire position of the driving piston (8) and a pressure force on the driving piston (8) reduces when the braking element (23) on movement of the driving piston (8) in the forward direction of travel, comes to rest opposite the wedge-shaped surface (18). When this is done, the driving piston can be guided smoothly and returned under braking into its ready-to-fire position, and held there securely.

### BACKGROUND OF THE INVENTION

The invention relates to a piston support located in a piston guide enclosing the piston.

EP 0 346 275 B1 discloses a prior art piston support for an explosive powder driven setting tool comprised of a piston support and a displaceable driving piston, characterized in that a recess in the piston guide opens radially inwardly towards the driving piston and is provided with braking balls adjacent to the driving piston and spring elements acting on the braking balls. In the ready-to-fire position of the braking balls the stress of an annular spring presses them against the surface of the driving piston shaft. If the driving piston is displaced in the driving direction, it carries the braking balls at the start of the movement. The braking balls then stress the annular spring, whereby the contact surface conveys the radial spring force of the annular spring into the braking balls. The braking balls urged radially against the driving piston shaft thus exert a braking action on the driving piston. Even with a minimum displacement of the driving piston towards the rear, the braking action can be suspended, in that the braking balls move opposite the driving direction and the stress is released from the annular spring. After the stress of the annular spring is released the braking balls are no longer urged against the shaft of the driving piston. Thus the braking action is suspended relative to the driving piston.

### SUMMARY OF THE INVENTION

The primary object of the invention is to provide a piston support of the general type described above, for securely holding the driving piston in the ready-to-fire position, and braking it only over a minimum path of its forward movement and braking it again only shortly before returning to its ready-to-fire position.

A piston support according to the invention can, for example, be used in an explosive powder driven setting tool or in one that is driven by the ignition of an air/combustible gas mixture. In such instance, the driving piston is characterized by a cylindrical section and a wedge-shaped section adjacent thereto and inclined rearwardly towards the central axis of the piston. In this fashion, the piston support receives at least one braking element that in the ready-to-fire position presses against the cylindrical section of the piston and the cylindrical section's pressure on the driving piston reduces, when on movement of the driving piston in the leading or driving direction, the braking element comes to lie opposite the wedge-shaped section.

If the driving piston is ready-to-be operated, that is, in its starting or ready-to-fire position, it is held securely in that position by the braking element, since it is pressing with sufficient braking force against the cylindrical section of the driving piston. When the setting tool is fired, the driving piston is driven in the driving or the leading direction (the setting direction), so that the wedge-shaped surface lies opposite the braking element. Since the wedge-shaped section is inclined inwardly towards the trailing end of the driving piston, it increasingly moves away from the braking element so that the braking element no longer exerts such a high pressure force and ultimately no pressure force on the driving piston. The driving piston now runs relatively freely in the driving direction. If it reverses its direction of travel, initially it is not braked at all by the braking device until the wedge-shaped surface again makes contact with it and the braking element only now begins to hold it. The overall forward and backward movement of the driving piston thusly proceeds relatively smoothly, whereby the driving piston is positioned securely in its ready-to-fire position.

The inclination and the axial length of the wedge surface are selected in accord with the behavior of the braking element as is required for braking of the piston shortly before reaching its ready-to-fire position. When this is done the wedge surface can extend up to the rearwardly situated head of the piston or extend into a rear cylindrical section whose diameter can correspond again to that of the leading end cylindrical segment, if care is taken that the rearward cylindrical section does not reach the braking element in any piston position whatsoever.

In the inventive arrangement the wedge-shaped surface can be either a planar surface or of a tapered surface. Thereby the form of the braking element can be adapted to the form of the surface. It is also possible, however, to design the braking element as a sphere, roller, cylinder or disk and can be made to roll or glide over the piston surfaces.

In this regard the braking element, in a further embodiment of the invention, can lie in a recess radially outward in the piston guide and can be biased inwardly by spring force in the direction towards the driving piston.

This can, for example, be achieved in that a bottom or base surface of the recess is inclined inwardly in the forward direction towards the piston central axis and the braking element is pressed in the forward leading direction against a wall of the recess by means of an axially extending spring. In this instance, the braking action on the driving piston can be adjusted by the inclination of the base of the recess and the wedge surface of the driving piston.

It is also possible to design the braking element itself to be elastic at least in the radial direction of the driving piston. It could then be maintained biased between a base area of a recess and the driving piston in order to yield on movement of the driving piston in the forward direction, and the wedge-shaped section area moves along under the braking element.

Elasticity in the radial direction of the driving piston could also be provided for the braking element, however, also the base region area of the recess itself can be designed yieldingly elastic or resilient.

It would be further advantageous to provide braking elements equiangularly spaced from one another around the periphery of the driving piston which would induce a substantially symmetrical braking force radially on the driving piston so that it is not unevenly stressed.

### BRIEF DESCRIPTION OF THE DRAWING

An exemplary embodiment of the invention is described more completely in the following with reference to the drawing, wherein:

FIG. 1 is a side view of a setting tool partly in cross-section in which a piston support embodying the invention is used;

FIG. 2 is an axial section through the piston support according to the invention with the driving piston in the ready-to-fire position; and

FIG. 3 is the axial section similar to FIG. 2 with the driving piston displaced in the setting or forward direction.

### DETAILED DESCRIPTION OF THE INVENTION

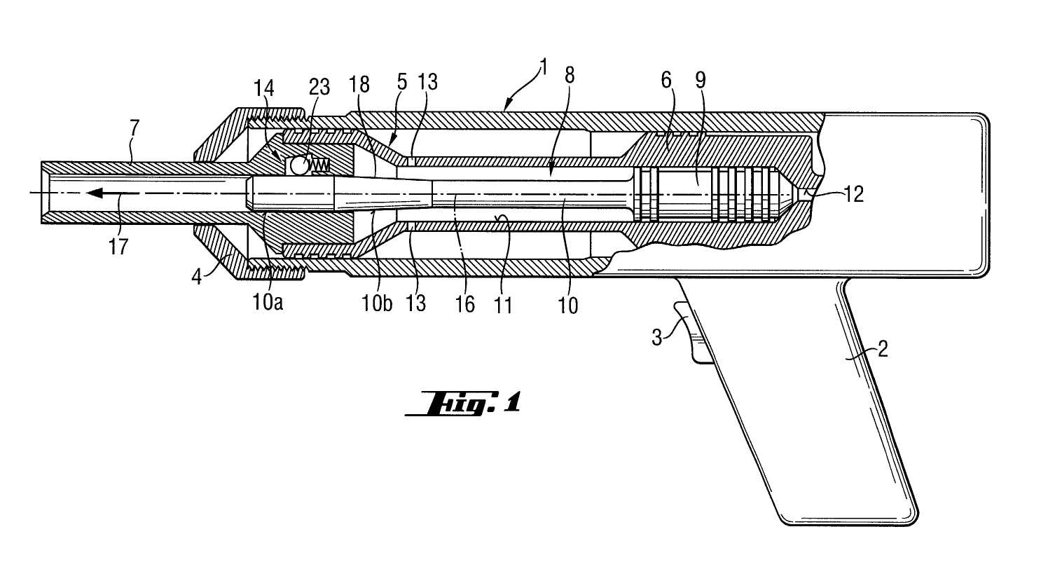

FIG. 1 represents an explosive powder driven setting tool with piston support according to the invention. Alternatively, it could also be a setting tool, that is operated by ignition of an air/combustible gas mixture.

The setting tool shown in FIG. 1 is comprised of a housing 1 with a handle 2 and a triggering device 3. A stop collar 4 is screw connected to the leading end on the driving side of the housing 1. A two-part piston guide 5 is located in the housing. The piston guide 5 is comprised of a trailing end part 6 and a leading end part 7. A driving piston 8 is situated in the piston guide 5 and has a trailing end head 9 guided within part 6 and a shaft 10 guided by part 7. A channel 12 for the passage of the expansion gases of an explosive powder drive charge opens into a guide passage 11 of the piston guide 5 in the rear of part 6. At the front end of part 6, passages 13 are situated for the outflow of air situated upstream of the head 9 at the time of forward movement of the driving piston 8. The leading end region of part 6 concentrically overlaps the trailing region of part 7. Part 7 emerges from the stop collar 4 and forms a muzzle. The trailing end of part 7 projects inwardly into the guide passage 11 in the piston guide 5 in the form of a tubular stop and in this fashion forms a limiting stop for the forward travel of the driving piston 8.

The shaft 10 of the driving piston 8 is formed by a leading cylindrical section 10a and a wedge-shaped or conically-shaped section 10b connected rearwardly of the cylindrical section and extending towards the trailing end of the driving piston 8. The conically-shaped section 10b is characterized by a wedge-shaped area inclined inwardly towards the piston central axis so that the pointed tip of the cone would point in the direction towards the head 9 of the driving piston 8.

A recess or receiving space 14 situated at the leading end of the piston guide serves to receive one or a plurality of braking elements 23.

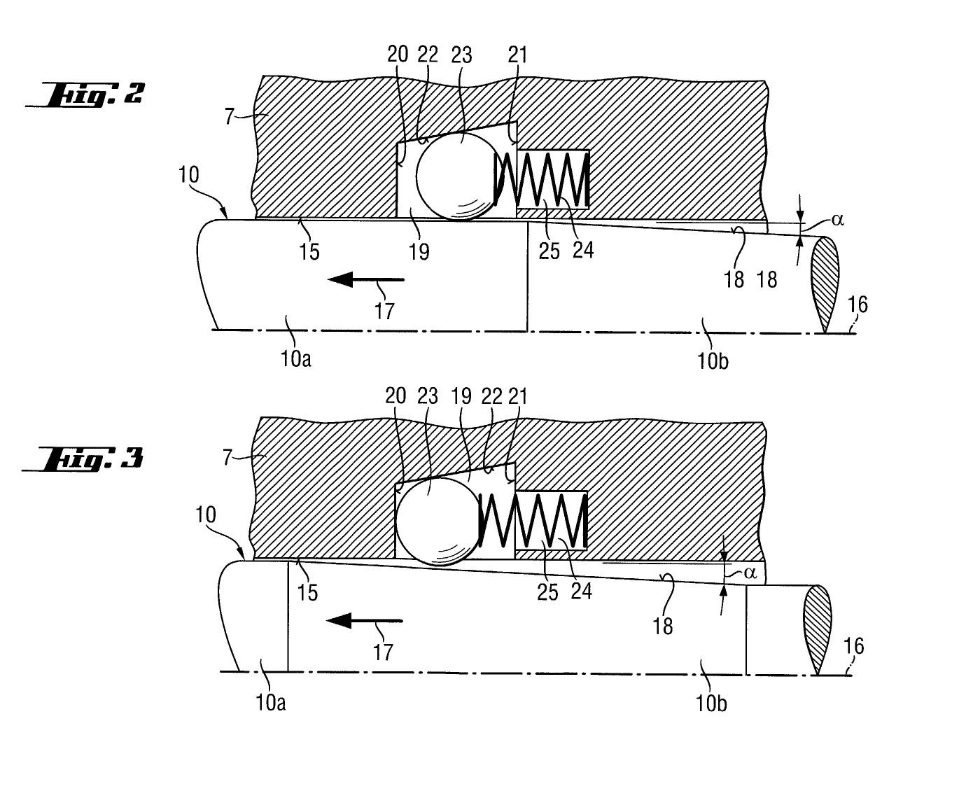

FIGS. 2 and 3 depict in enlarged representation the relationships of the recess or receiving space 14 of the setting tool according to FIG. 1.

The shaft 10 of the driving piston 8 is guided in a forward part 15 of the piston guide 5 that is located in part 7. The central axis of the shaft 10 is identified by reference numeral 16. In FIGS. 2 and 3 the leading cylindrical section 10a of the piston shaft 10 and the conically shaped section 10b of the shaft connecting thereto are shown extending towards the trailing end of the driving piston 8. The setting direction or the direction of forward travel of the driving piston 8 is indicated by the arrow 17. The conical section 10b of the shaft 10 has a wedge-shaped or circumferential surface that is inclined at an angle α relative to the piston central axis 16. Starting from the cylindrical segment 10a the angle α opens in the direction towards the trailing end of the driving piston 8. The head 9 of the driving piston 8 can either connect directly to the conical section 10b or for a further axially extending cylindrical section. This is not shown in detail.

At the trailing end of the leading part 7 there is a peripheral recess 19 that is designed axially by separate spaced radially extending walls 20 and 21 and by a base or bottom wall 22. The radially extending walls 20 and 21 are each situated in planes running perpendicular to the piston central axis 16, while the base 22 is designed as a conical surface and is inclined inwardly toward the leading end of the piston central axis 16. Inside the peripheral recess 19 spherical braking elements 23 lie, under similar angular conditions relative to one another peripherally relative to the driving piston 8. Each spherical braking element 23 is compressed by means of compression springs 24 extending axially to the wall 20, and the compression spring 24 is situated in an recess 25 extending axially in part 7.

FIG. 2 represents the piston support with the driving piston 8 in the ready-to-fire position. Here the spherical braking element 23 is biased by the compression spring 24 against the inclined base 22, whereby the force of the compression spring 24 is diverted radially towards the driving piston. The braking element 23 consequently presses against the cylindrical section 10a of the shaft 10 and holds the driving piston 8 in the ready-to-fire position.

If after firing of the setting tool the driving piston 8 moves somewhat in the setting direction 17, it is initially braked by the action of the ball 23 in pressure contact with the cylindrical section 10a. If the braking element or ball 23 reaches the conical section 10b, then the compression spring 24 initially biases the ball 23 somewhat farther in the direction towards the wall 20, so that a certain friction between the ball 23 and the shaft 10 is maintained. When this is done, it must be assured that the bottom wall 22 is somewhat steeper than the wedge-shaped surface 18. Finally, the ball 23 comes to rest at the leading lateral wall 20, whereby the wedge-shaped surface 18 continues to more farther away from the wall of the piston guide passage 15 with further movement of the driving piston 8 in the setting direction 17, so that ultimately the force of the compression spring 24 can no longer be transferred via the ball 23 to the shaft 10. The shaft is now free. The corresponding condition is shown in FIG. 3.

With movement of the driving piston 8 opposite to the setting direction 17, the ball 23 is initially driven by the wedge surface and the spring 24 is compressed. In this instance, it must be assured that the base 22 again runs steeper than the wedge-shaped surface 18. Therefore, the ball 23 can move to the left as shown in FIG. 3. Finally, the cylindrical section 10a runs under the ball 23 so that now, again, the force of the compression spring 22 is directed by the ball 23 against the cylindrical section 10a, whereby the ball 23 rests on the inclined base surface 22. This condition corresponds to that shown in FIG. 2.

What is claimed is:

1. A piston support for an axially extending driving piston (8) in a setting tool, wherein said piston (8) comprises a leading end for driving an element from the setting tool and opposite trailing end, said piston (8) having an axially extending cylindrical section (10a) closer to the leading end and axially extending from said cylindrical section (10atowards the trailing end of said piston (8), a wedge-shaped section (10b) having a wedge surface (18) being inclined inwardly towards said piston axis (16) in the direction towards the trailing end of said piston (8), said piston (8) is located within an axially extending piston guide (5) having a leading end and an axially spaced trailing end, said piston (8) having a ready-to-fire position within said piston guide (5) and being displaced from the ready-to-fire position towards the leading end of said piston guide when the setting tool is fired, at least one braking element (23) mounted in said piston guide (5) in the region of the ready-to-fire position in pressure contact with said cylindrical section (10a) and the pressure contact reduces as said piston (8) moves towards the leading end of said piston guide (5) and said braking element is located opposite said wedge surface (18).

2. A piston support, as set forth in claim 1, wherein said wedge surface (18) is an axially extending conically shaped surface.

3. A piston support, according to claim 1, wherein said the braking element (23) is one of a ball, roller, cylinder, or plate.

4. A piston support, as set forth in claim 3, wherein said braking element (23) is seated in a recess (19) extending radially outwardly in said piston guide (5) and means in said piston guide biasing said braking element (23) inwardly towards said driving piston (8).

5. A piston support, as set forth in claim 4, wherein said recess (19) has a base (22) spaced radially outwardly from said piston (8) and expending generally in the axial direction of said piston, said base inclined relative to the axis of said piston outwardly towards the trailing end of said piston, and said means biasing said braking element towards the leading end of said piston in the direction of a wall (20) of said recess (19) extending perpendicular to said piston axis and closer to the leading end of said piston guide.

6. A piston support, as set forth in claim 1, wherein said braking element is an elastic element at least radially of said piston (8).

7. A piston support, as set forth in claim 5, wherein said base (22) of said recess (19) is one of elastic and resilient.

8. A piston support, as set forth in claim 1, wherein a plurality of said braking elements (23) are positioned in said piston guide (5) equiangularly spaced apart around said piston (8) oppositely to said wedge surface (18).

9. A piston support, as set forth in claim 1, wherein said means comprises an axially expending compression spring.
